(19) United States
(12) Patent Application Publication
(10) Pub. No.: US 2018/0145834 A1
(43) Pub. Date: May 24, 2018

(54) Providing a Security Process for Wireless Devices

(71) Applicant: Arun Dharankar, Nashua, NH (US)

(72) Inventor: Arun Dharankar, Nashua, NH (US)

(21) Appl. No.: 15/818,732

(22) Filed: Nov. 20, 2017

Related U.S. Application Data
(60) Provisional application No. 62/424,258, filed on Nov. 18, 2016.

(51) Int. Cl. H04L 9/32; H04L 29/06; H04W 12/04; H04L 9/30

(52) U.S. Cl. CPC H04L 9/3247; H04L 63/06; H04L 69/324; H04L 9/30; H04L 9/3228; H04W 12/04

(57) ABSTRACT

The present invention is a computer-implemented method for providing a security process for wireless devices. The method includes receiving a beacon frame at a beacon receiver. The beacon frame includes a digitally signed beacon identifier. The beacon frame is transmitted by a beacon transmitter. The method further includes transmitting a message with the beacon identifier from the beacon frame received by the beacon receiver to an arbiter for digital signature validation. The method further includes validating the beacon identifier from the message at the arbiter, and communicating a result of the beacon identifier validation by the arbiter back to the beacon receiver.

### CROSS REFERENCE TO RELATED APPLICATIONS

This application claims priority under 35 U.S.C. 119(e) to U.S. Provisional Pat. App. No. 62/424,258, titled “Providing a lightweight security process for wireless devices” and filed on Nov. 18, 2016, which is also hereby incorporated by reference in its entirety for all purposes.

### FIELD OF THE INVENTION

The subject technology generally relates to wireless devices particularly Internet-of-Things (IoT) and, in particular relates to providing a security process.

### BACKGROUND OF THE INVENTION

With the development and widespread use of the wireless devices along with the recent trend of Internet-of-Things (“IoT”) devices, the security is a major area of concern. Many IoT devices vendors appear ignore the security aspects, creating an unsafe network of IoT devices among other wireless and wired devices in home automation, medical, industrial and other industries.

### BRIEF SUMMARY OF THE INVENTION

The disclosed subject matter relates to a method for providing a security process for wireless devices including IoT devices using an external device known as Arbiter thereby solving the issue of relatively small footprint in terms of computing power and memory in IoT devices and building a safe network of IoT devices among other wireless and wired devices in home automation, medical, industrial, and other industries. The method includes receiving a beacon frame at a beacon receiver. The beacon frame is transmitted by a beacon transmitter. The beacon frame contains a beacon identifier that is digitally signed. The method also includes transmitting a message with the beacon identifier from the beacon frame received by the beacon receiver to an arbiter for digital signature validation. The method also includes validating the beacon identifier from the message at the arbiter and communicating a result of the beacon identifier validation by the arbiter back to the beacon receiver.

The disclosed subject matter further relates to a non-transitory computer-readable medium. The computer readable medium includes instructions that, when executed by a computer, cause the computer to implement a method for providing a security process for wireless devices including IoT devices using an external device known as Arbiter thereby solving the issue of relatively small footprint in terms of computing power and memory in IoT devices and building a safe network of IoT devices among other wireless and wired devices in home automation, medical, industrial, and other industries. The instructions include code for receiving a beacon frame at a beacon receiver. The beacon frame is transmitted by a beacon transmitter. The beacon frame contains a beacon identifier that is digitally signed. The instructions also include code for transmitting a message with the beacon identifier from the beacon frame received by the beacon receiver to an arbiter for digital signature validation. The instructions also include code for validating the beacon identifier from the message at the arbiter. and communicating a result of the beacon identifier validation by the arbiter back to the beacon receiver.

The disclosed subject matter further relates to a system. The system includes one or more processors. The system also includes a memory. The memory includes instructions that, when executed by the one or more processors, cause the one or more processors to implement a method for providing a security process for wireless devices including IoT devices using an external device known as Arbiter thereby solving the issue of relatively small footprint in terms of computing power and memory in IoT devices and building a safe network of IoT devices among other wireless and wired devices in home automation, medical, industrial, and other industries. The instructions include code for receiving a beacon frame at a beacon receiver. The beacon frame is transmitted by a beacon transmitter. The beacon frame contains a beacon identifier that is digitally signed. The instructions also include code for transmitting a message with the beacon identifier from the beacon frame received by the beacon receiver to an arbiter for digital signature validation. The instructions also include code for validating the beacon identifier from the message at the arbiter and communicating a result of the beacon identifier validation by the arbiter back to the beacon receiver.

It is understood that other configurations of the subject technology will become readily apparent to those skilled in the art from the following detailed description, where various configurations of the subject technology are shown and described by illustration. As will be realized, the subject technology is capable of other and different configurations and its several details are capable of modification in various other aspects, all without departing from the scope of the subject technology. Accordingly, the drawings and detailed descriptions are to be regarded as illustrative in nature and not as restrictive.

### BRIEF DESCRIPTION OF THE DRAWINGS

The features of the subject technology are outlined in the appended claims. However, for the purpose of explanation, several aspects of the disclosed subject matter are set out in the following figures.

FIG. 1 illustrates an example of a network to provide a security process for wireless devices in accordance with some embodiments.

FIG. 2 illustrates a sample beacon frame with its relevant fields to provide a security process for wireless devices, in accordance with some embodiments.

FIG. 3 illustrates an example of a block diagram of a server in accordance with some embodiments.

FIG. 4 illustrates a flow chart in accordance with some embodiments.

FIG. 5 illustrates a flow chart in accordance with some embodiments.

FIG. 6 illustrates another network system diagram in accordance with some embodiments.

FIG. 7 illustrates a flow chart in accordance with some embodiments.

The detailed description set forth below is intended as a description of various configurations of the subject technology and is not intended to represent the only configuration in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details. In some instances, well-known structures and components are shown in block diagram form in order to avoid obscuring the concept of the subject technology.

Overview

As noted above, with the development and widespread use of the wireless devices along with the recent trend of IoT (Internet of Things) devices, the security is a major area of concern. Many IoT devices vendors appear to ignore the security aspects, creating an unsafe network of IoT devices among other wireless and wired devices in home automation, medical, industrial and other industries.

As the foregoing illustrates, an approach that would allow a security process for wireless devices, including IoT devices, using an external device, referenced as an Arbiter is disclosed, thereby solving the issue of security in IoT devices, and building a secure network of IoT devices among other wireless and wired devices in home automation, medical, industrial, and other industries as may be relevant. The Arbiter provides many services such as beacon id generator, a beacon id signer, a beacon id verifier, a device id digital certificate lookup service, a media access controller (MAC) address assignment service. The Arbiter may have the above listed services collocated on a single server, or may be distributed on different servers. The Arbiter may be installed in active-standby pair for redundancy or may be in active-active mode for load sharing. The Arbiter may be located in the operator's core network. The Arbiter may be located in an enterprise network as well, or where such secured network services may be desired.

In some embodiments, a wireless network system may include an access point (AP) or a Bluetooth beacon transmitter. The AP may also be referenced in this disclosure as beacon transmitter, or Bluetooth low energy (BLE) transmitter. The AP may be a mobile phone, or any wireless device capable of generating and transmitting a beacon. The wireless network system may further include the Arbiter that provides various services listed above. The wireless system may include a variety of wireless devices, such as a mobile phone, a smart phone, a personal digital assistant (PDA), a laptop, a tablet, etc. The variety of wireless devices are able to receive the beacon transmitted by the AP and may connect to the AP or may process the beacons transmitted by AP. The variety of wireless device may include any device that may connect to Local Area Network (LAN) or Wide Area Network (WAN) using a wireless protocol, e.g., 802.11, Wi-Fi, Bluetooth, ZigBee, etc. and so on. The wireless device may be an IoT device, a smart phone, any device that is capable to connect to internet or intranet using Wi-Fi, Bluetooth, ZigBee or similar technology.

In some embodiments, the beacon frame may be transmitted by a beacon transmitter of a wireless device. The wireless device may be an access point (AP) or a Bluetooth beacon transmitter, a smart phone, etc. The beacon frame may include a beacon identifier. The beacon identifier and other fields of the beacon frame may be digitally signed. The beacon frame broadcast may be received by other wireless device. The other wireless device, upon receipt of the beacon frame, may transmit a message with the signed beacon fields, extracted from the beacon frame, to the arbiter for digital signature validation. In an alternate embodiment, the other wireless device may locally perform validation of the signed beacon fields. The arbiter validates the signed beacon fields received in the message, and sends response back to the other wireless device. Please note that the beacon transmitter may be an Access Point. The beacon transmitter may be a Bluetooth Low Energy (BLE) transmitter or likes of it, advertising services it offers. The other wireless device, upon successful validation of the beacon fields can trust the identity of the source or the access point.

One of the common computer security breaches is spoofing other devices, and thereby gain access to resources and privileges that are not allowed otherwise or disrupt normal network or device operations. The spoofing may be done by various means, depending on the technology used. In the world of connected devices, the devices are identified by their respective unique identifiers, which typically may be network address of the device. This address is not the logical address such as IP address, which is likely to change and not always statically assigned, but the low level physical address of the device, media access control address (MAC address). The advantage of using MAC address is that they are unique to each device, and programmed into the hardware of the device. This applies to the computing servers, desktops, laptops and so on. However, Internet-of-Things (IoT) devices poses a special challenge since the MAC address may be soft-programmed instead of hard wired in the IoT device. Such IoT devices may be a Bluetooth low energy transmitters advertising various services, or Wi-Fi devices. If a rogue device in the network is able to broadcast a beacon with a spoofed MAC address, the signed beacon may help to identify whether the beacon is valid.

As described above, this disclosure proposes a scheme that does not rely on the MAC address of the IoT devices or BLE transmitters that may be spoofed, but instead uses a digitally signed beacon. Since the IoT devices may have a small footprint (computing/memory resources), the scheme proposes making use of an external device, referenced in this disclosure as an Arbiter, which may perform the digital signature validation.

The digital signature may be generated uniquely for every beacon frame transmitted. The signature generation/calculation may be made for the contents of the entire beacon frame excluding the signature and frame check sequence (FCS) or cyclic redundancy check (CRC), but including the timestamp in the beacon. If the Beacon Transmitter device has enough power, it may use public key cryptography. But, the proposed solution is not limited to devices, protocols, applications, or networks, etc. mentioned in this disclosure, but a person skilled in the art may recognize and apply the disclosure made here to other devices, protocols, applications, or network, etc.

Digital signing of messages does not necessarily mean using public key cryptography, but it may encrypt using one-time passwords, passphrases, passkeys, pads, and may be recognized as OTP in this disclosure. Such signed/encoded beacons may be validated by the beacon signature validating service, which may be a service provided by Arbiter. Beacon signature validating service may also be referenced as beacon id verifier service.

The beacon Transmitter may sign the beacon elements or beacon fields and the digital signature may be added as a beacon element. The digital signature may be time constrained in that it may be valid only for a short-specified duration. The arbiter may be available over the Internet, or intranet as needed, for any beacon receivers to validate. One of the many beacon elements may be the device's MAC address

This solution mentioned in this disclosure is agnostic to the underlying transport technology and may be applied to various schemes prevalent in the IoT space, such as Wi-Fi, Bluetooth, ZigBee, and may also be applied in radio access network such as 2G, 3G, 4G, 5G, etc.

It may be desirable that wireless devices may require their address to be anonymous or obscured.

A protocol may be devised such that the MAC address of the device may be acquired dynamically. This MAC address may be assigned for a certain period of time, after which the IoT device needs to renew the MAC address, or possibly a different address. This allows the IoT device the flexibility to change its identity, and ability to communicate with other devices.

As the IoT device is powered on it attempts to use one of ephemeral MAC addresses, which are not the permanent ones, but are reserved to acquire the MAC address during operational phase, to communicate with an external address assignment service. The address assignment service runs on another device such as Arbiter. The IoT device may communicate with the Arbiter using a well-defined protocol such as TCP/IP. The cryptography method used may be based on public key cryptography for securing the communication, and may use digital signature to assert the device's identity. The address assignment service leases a new MAC address for the device to use. The address may be time constrained for use by the lease.

In mission critical applications, such as Power Plants, that require deterring passive snooping, decoy devices may be employed.

Decoy devices may get their MAC address re-assigned by a central service known as Address Assignment Service, which may be run as part of Arbiter device, such that the device appears to be moving when it is really is not. This may be done in such a way that a set of devices may be made to appear and behave like a single device moving along a certain physical path, where each such Decoy device acquires its address for a certain period of time, and then releases it, which is then assigned to the next predetermined device by the Address Assignment Service. The passive snoopers performing any analytics to gain understanding the network and devices in this application may be deterred by the technique disclosed above.

This scheme relies on a central Arbiter which will be configured to lease MAC addresses to a group of transmitters or IoTs (Decoy group) in a preconfigured round-robin fashion.

To deter/defeat any passive snoopers who use analytics to gain information about secured devices, the secured devices as well as the decoys may periodically transmit packets which may not have any purpose other than to prevent any analytics.

### FIGURES

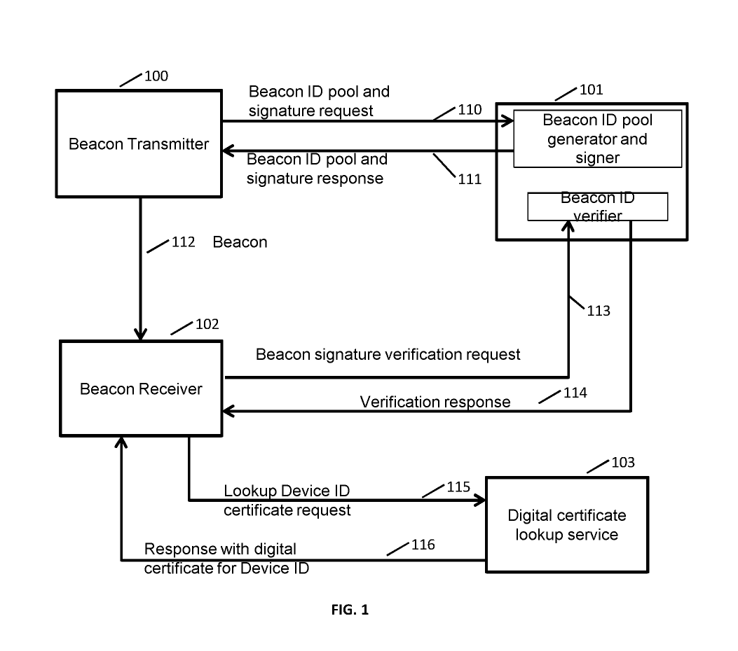

FIG. 1 illustrates an example of a block diagram of a network showing communication between different entities or modules to provide a security process for the wireless devices.

As shown in FIG. 1, in accordance with some embodiments, the network includes a beacon transmitter 100, a beacon receiver 102, a server 103 providing device digital certificate lookup service, a server 101 providing beacon id generator and signer, and beacon id verifier services. The server 103 and the server 101 may be collocated on a single server or may be distributed on different servers, and a server 103 providing device ID digital certificate lookup service. The beacon transmitter 100 may be an access point (AP), a Bluetooth low energy (BLE) transmitter tags/devices, or a wireless device enabled to transmit a beacon. The server 101 provides beacon id generator and signer services. The beacons may be sent typically at the rate of few per second, e.g., may be 20 beacons per second or less in case of Wi-Fi, or 10 beacons per second or less in case of BLE, depending on the device as provisioned by a user. To sign every beacon, the hardware needs to have enough compute power, and a beacon transmitter may not have enough compute power to do so. Therefore, the beacon transmitter may send a request 110 for assignment of a pool of signed beacons from the server 101. The server 101, having beacon id generator service, generates a pool of beacons and digitally signs the beacons. The server 101 further responds with beacon id pool and signature response 111 to the beacon transmitter 100. The server 101 may digitally sign beacons with public key cryptography or a proprietary/symmetric cryptography.

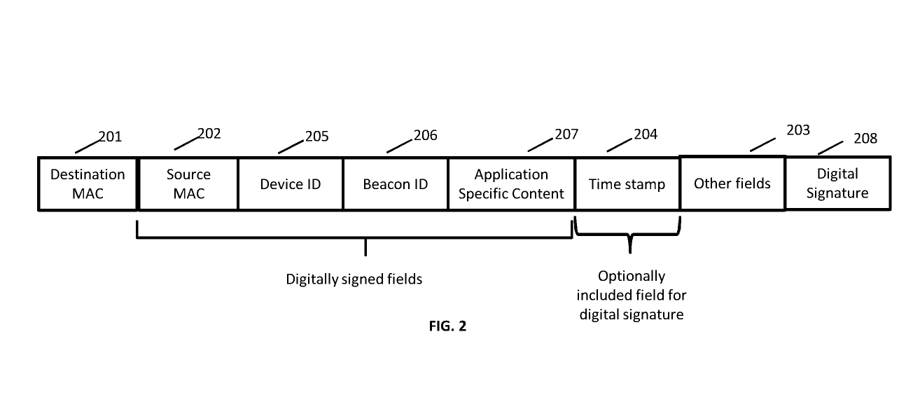

As shown in FIG. 1, the beacon transmitter 100 transmits a beacon 112. The beacon 112 has beacon frame as shown in FIG. 2. The beacon frame 112, as shown in FIG. 2, may include a digital signature field 208. The digital signature field 208 may be based on fields that are digitally signed. As an example, the fields of the beacon frame that are digitally signed may be a device identifier 205 also may be known as Device ID 205, a source MAC address 202, a beacon ID 206, any or all application-specific content 207. However, the fields that may be digitally signed are not limited to the fields mentioned here, as such other fields such as a timestamp 204 may also be included in the digitally signature 208. The digital signature may be generated uniquely for the beacon frame 112. The digital signature generation may include the contents of the entire beacon frame 112 including time stamp but excluding the digital signature, and frame check sequence or cyclic redundancy check fields. The beacon identifier generator service 101 generates the beacon ID and also includes the digital signature field 208. The beacon frame may be valid only for a short configurable specific time duration. The digital signature or the beacon identifier may be generated using public key cryptography to transmit in the beacon frame 112. If the beacon transmitter 100 has enough power, the digital signature or the beacon identifier may be generated by the beacon transmitter 100 using public key cryptography. The beacon transmitter 100 may be an access point using Wi-Fi, ZigBee, Bluetooth or other similar technologies. The beacon identifier or the digital signature generation is not limited to using the public key cryptography, and as such one-time passwords, passphrases, passkeys, or pads (OTP) may also be used. As described, the beacon ID generator and signing may be performed by the server 101 or alternatively by the beacon transmitter 100 depending on the compute power of the beacon transmitter 100. It may also be possible that the source MAC address 202 and the Device ID 205 may be the same and so only one of the source MAC address 202 or the Device ID 205 may be present in the Beacon 112.

As shown in FIG. 1, in accordance with some embodiments, the beacon frame 112 is broadcast and that may be received by a beacon receiver 102. The beacon receiver 102 may be any device capable to receive the beacon, the device may as such an IoT device, a smart phone, a mobile phone, a laptop, a desktop, a personal digital assistant, a tablet, or any wireless device supporting Wi-Fi, Bluetooth, ZigBee or similar protocols. The beacon receiver 102 upon receipt of the beacon 112, extracts device id 205 from the beacon 112 and sends a lookup Device ID certificate request 115 to the server 103 that may provide a digital certificate lookup service. The digital certificate lookup service may have a map of a device ID to digital certificate associations. The digital certificate may be based on a public key cryptography. The server 103 responds to the request 115 with digital certificate for the Device ID 116. The beacon receiver 102 if successfully receives digital certificate in response 116 from the server 103, then the beacon receiver 102 validates the beacon locally using the digital certificate received from the server 103.

If the beacon receiver 102 does not receive the digital certificate from the server 103 then the beacon receiver 102 sends the fields of the beacon 112 that may be included in the digital signature 208 and the digital signature 208 to the server 101 for beacon ID verification. The beacon receiver 102 sends beacon signature verification request 113 that includes the digital signature 208 and the signed fields of the beacon 112. The server 101 verifies the signature and sends verification response 114 to the beacon receiver 102. The server 101 when it generated beacon pool and signed the beacons, it stores the symmetric cryptographic keys for that device ID for later verification of the beacons.

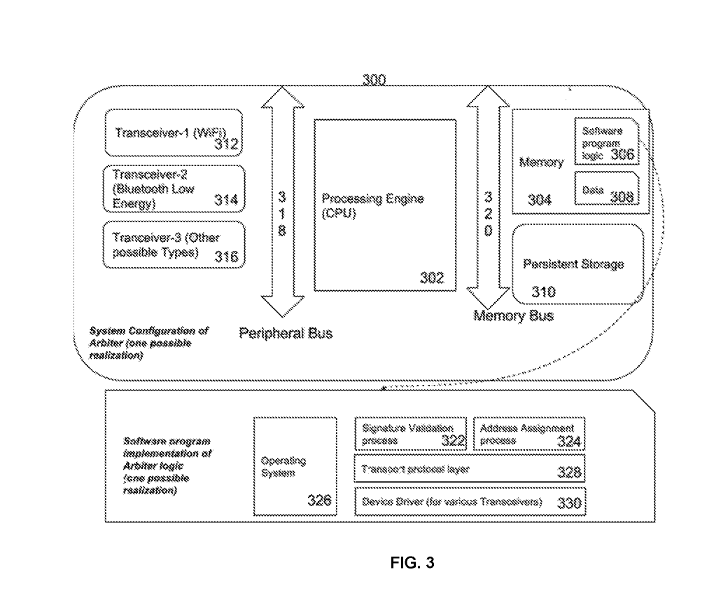

FIG. 3 is a block diagram of a system, an Arbiter 300, that provides or implements a security process for wireless devices. As shown FIG. 3 has transceiver-1 (Wi-Fi) 312, transceiver-2 314, transceiver-3 316. Transceivers 312, 314, and 316 communicates radio frames including beacons. Peripheral bus 318 provides communication between transceivers 312, 314, 316 and CPU 302. Memory bus 320 allows CPU 302 to access memory 304 and persistent storage 310. The memory 304 may have software program logic 306 and data 308. The software programs and computer instruction may reside in software program logic 306. The Arbiter 300 may also include operating system 326, and may host various services such as signature validation process/service 322, address assignment process/service 324, transport protocol layer 328, and device drivers 330 for transceivers 312, 314, and 316.

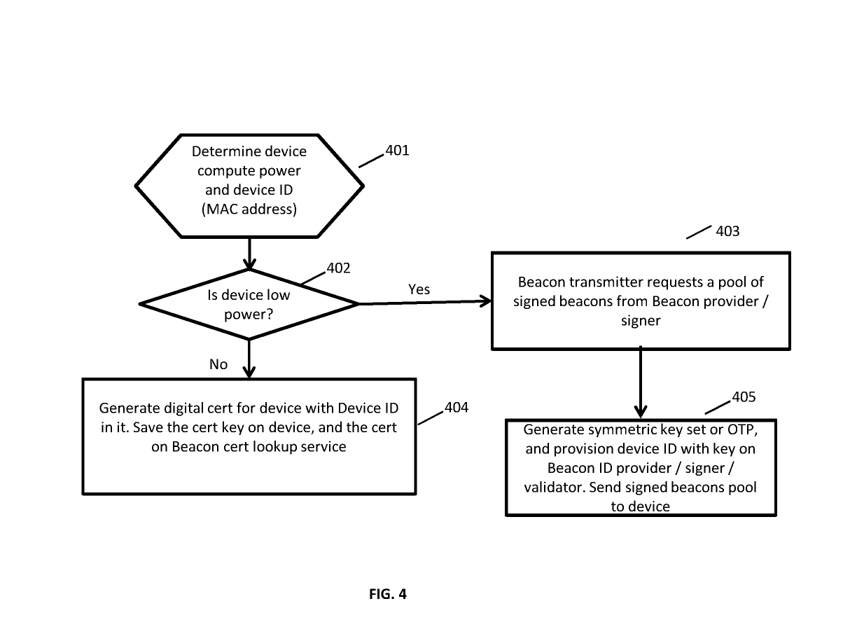

FIG. 4 is a flow chart in accordance with some embodiments. FIG. 4 flow chart describes the Beacon ID pool generation and signing of the Beacons. At step 401, programmed logic on the beacon transmitter 100 determines its computer power and device ID or MAC address. At step 402, the beacon transmitter 100 further decides whether the beacon transmitter 100 is a low compute power device. At step 403, when the beacon transmitter 100 is low compute power device, the beacon transmitter sends a request 110 for beacon pool generation and signing the beacons to server 103. At step 405, the server 101, generates symmetric key sets or one-time password (OTP) to sign the beacons in the pool. The server 101 then sends signed beacons pool to the beacon transmitter 100 as shown in step 405. If the beacon transmitter 100 has enough compute power, then at step 404, the beacon transmitter 100 generates a digital certificate with Device ID in it, saves the certificate key on the device. The beacon transmitter 100 sends the digital certificate to server 103 for storage.

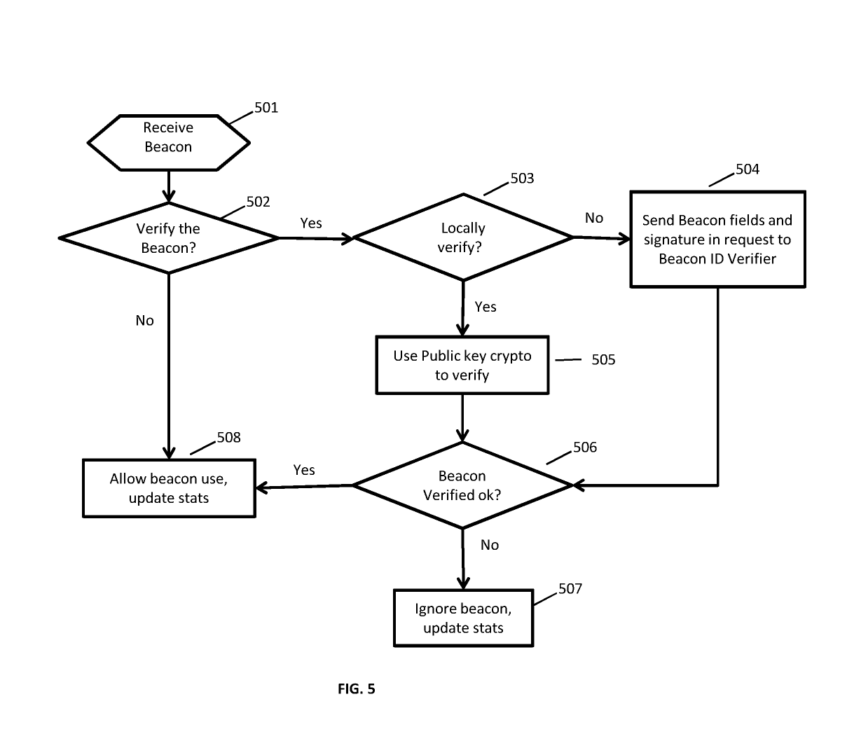

FIG. 5 is a flow chart in accordance with some embodiments. As shown in FIG. 5, at step 501, the beacon receiver 102 receives beacon 112. At step 502, the beacon receiver decides whether the beacon 112 needs to be verified, as not each received beacon may be verified. Whether the received beacon needs to be verified may be based on an arbitrary logic. The arbitrary logic may be based on intent to keep the beacon verification traffic low. If the beacon needs to be verified as determined at step 502, at step 503, the beacon receiver 102 further determines if the beacon could be verified locally. The beacon receiver determines whether the beacon should be verified locally, based on the lookup Device ID certificate request 115 to the server 103 and the response from the server 103 with Digital Certificate for the Device ID. If the server does not respond with a Digital Certificate for the Device ID in 116, then at step 504, the beacon receiver 102 sends the beacon fields and digital signature extracted from the beacon 112 to the server 101 for beacon ID verification, else at step 505 the beacon receiver 102 use public key cryptography to verify the beacon. At step 506, if the beacon is verified OK, the beacon receiver allows the further processing of the beacon. At step 507, if the beacon verification fails, the beacon may be dropped. If the beacon 112 does not need to be verified as determined at step 502, the beacon may be processed further as per the device logic as shown in step 508. At step 507 and at step 508, an appropriate statistic may be updated.

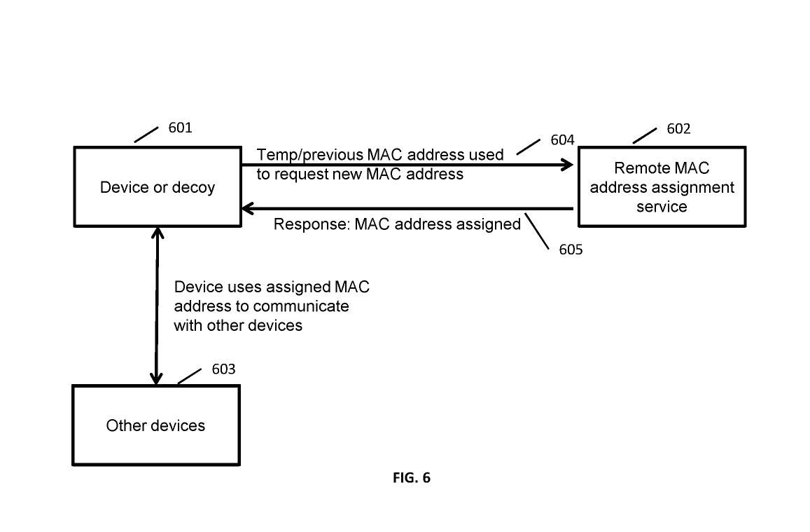

FIG. 6 shows an another network system diagram in accordance with some embodiments. As shown in FIG. 6, the network includes a wireless device 601, a remote MAC address assignment service server 602 and other devices 603. The wireless device 601 may be an IoT device, a smart phone, a mobile phone, a laptop, a desktop, or any wireless devices capable to connect to internet or intranet using Wi-Fi, ZigBee, Bluetooth, or similar technology. The other devices 603 may also be an IoT device, a smart phone, a mobile phone, a laptop, a desktop, or any wireless devices capable to connect to internet or intranet using Wi-Fi, ZigBee, Bluetooth, or similar technology. The device 601 at start uses a temporary MAC address from a pool of preconfigured MAC address pool. The device 601 sends request 604 to the server 602 for assignment of MAC address. The MAC address as assigned by the server 602 is valid for a specified time duration i.e. the server 602 leases the MAC address to the device 601. The server 602 responds the request 604 with assigned/leased MAC address 605 to the Device 601. The Device 601, uses the new MAC address assigned by the server 602 to communicate with the other devices 603 as shown. The device 601 may also be a decoy device. The decoy device deters passive analysis of the wireless device 601.

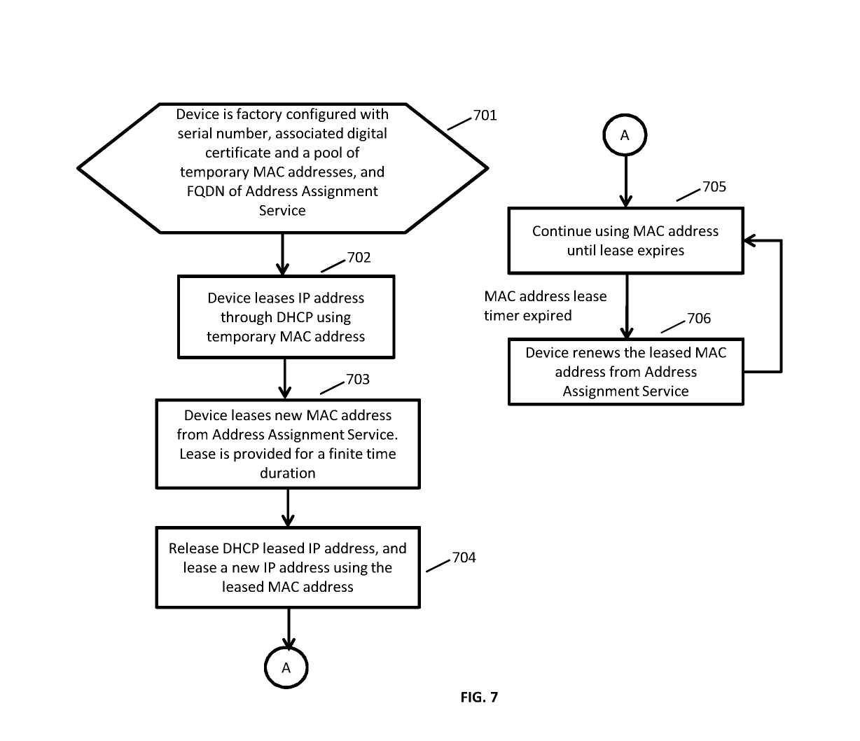

FIG. 7 shows a flow chart in accordance with embodiments. As shown in FIG. 7, at step 701, the device 601 upon power-on retrieves its own serial number, associated digital certificate, a pool of temporary MAC addresses, and a fully qualified domain name (FQDN) of Address Assignment service server 602. At step 702, the device 601, leases an IP address through DHCP using a temporary MAC address from the pool of temporary MAC addresses as mentioned in step 701. The device 601, at step 703, leases a new MAC address from the Address Assignment service server 602. The MAC address may be leased to the device 601 for a finite time duration. At step 704, the device 601 releases the DHCP leased IP address obtained at step 702, and leases a new IP address using the leased MAC address obtained in step 703. As shown in step 705, the device 601 continues to use the leased MAC address until the lease expires. Upon MAC address lease timer expiry, as shown in step 706, the device 601 renews the leased MAC address from the Address Assignment service server 602. At step 707, as shown, the DHCP IP address lease may be renewed. As shown, the lease renewal of the MAC address may be done periodically. Also, the DHCP IP address may also be renewed periodically.

### EXAMPLES

Non-Wi-Fi Access Point (AP) beacons: A Bluetooth technology, defined around the Bluetooth Low Energy (BLE) standard, provides for service advertisement, e.g., people going to a mall or walking by shops (or restaurants, repair shop, etc.) can receive BLE beacons sent by the shops on their BLE enabled smart phones. These beacons will include a unique ID for the service or include a short URL (e.g. something like http://go.og.le/a3xAdg) that a smart phone APP will use to find info about that shop/service on the Internet. Unlike use of Wi-Fi connect to an AP these BLE beacons are used as broadcasts to advertise a service. A similar technology is also now possible using Wi-Fi beacons. The disclosure made here enables securing of the beacons.

Dynamic assignment and changing of the MAC address may be better applicable for not only IoT type wireless devices (via Wi-Fi or Bluetooth, etc.) but also for laptops, phones etc. The use may be for defeating any one snooping wireless signals to identify location and possibly purpose of the MAC address, and possibly guess the kind of data being transmitted to/from the devices.

The above-described features and applications can be implemented as software processes that are specified as a set of instructions recorded on a computer-readable storage medium (also referred to as computable readable medium). When these instructions are executed by one or more processing unit(s) (e.g. one or more processors, cores of processors, or other processing units), they cause the processing unit(s) to perform the actions indicated in the instructions. Examples of computer readable media include, but are not limited to, CD-ROMs, flash drives, hard drives, RAM chips, EPROMs, etc. The computer-readable media does not include carrier waves and electronic signals passing wirelessly or wired connections.

In the specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronics systems, define one or more specific machine implementations that execute and perform the operations of the software programs.

A computer program (also known as program, software, software application, script, or code) can be written in any form of programming language, including compiled or interpreted languages, declarative or procedural languages, and it can be deployed in any form, including as a standalone program or as a module, component, subroutine, object, or another unit suitable for use in a computing environment. A computer program may, but need not correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

These functions described above can be implemented in digital electronic circuitry, in computer software, hardware, or firmware. The techniques can be implemented using one or more computer program products. Programmable processors and computers can be included in or packaged as mobile devices. The process and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a non-transitory machine-readable or non-transitory computer-readable medium (alternatively referred to as computer-readable storage media, machine-readable media, or machine-readable storage media). Some examples of such computer-readable media include RAM, ROM, read-only compact discs (CD-ROM), readable compact discs (CD-R), rewritable compact discs (CD-RW), read-only digital versatile discs (e.g., DVD-ROM, dual-layer DVD-ROM), a variety of recordable/rewritable DVDs (e.g. DVD-RAM, DVD-RW, DVD+RW, etc.), flash memory (e.g., SD cards, mini-SD cards, micro-SD cards, etc.), magnetic or solid-state hard drives, read-only and recordable Blu-Ray® discs, ultra density optical discs, any other optical or magnetic media, and floppy disks. The computer-readable media can store a computer program that is executed by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored in the circuit itself.

As used in this specification and any claims of this application, the terms “computer”, “server”, “processor”, and “memory” all refer to electronic or other technological devices. These terms exclude people or groups of people. For the purpose of the specification, the terms display or displaying means displaying on an electronic device. As used in this specification and any claims of this application, the terms “computer-readable media” and “computer readable medium” are entirely restricted to tangible, physical objects that store information in a form that is readable by a computer. These terms exclude any wireless, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, or any other available monitor types, for displaying information to the user and a keyboard and a pointing device, e.g., mouse or trackball, by which the user can provide input to the computer. Other kinds of devices can be used to provide for interaction with a user as well; for example, feedback provided to the user can be any form of sensory feedback, e.g., visual feedback, tactile feedback, or auditory feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication network include a local area network (“LAN”), an inter-network (e.g., the Internet), and peer-to-peer networks (e.g., ad-hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purpose of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and system can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element n singular is not intended to mean “one and only one” unless specifically so states, but rather “one or more.” Unless expressly stated otherwise, the term “some” refers to one or more. Pronouns in the masculine (e.g., his) include the feminine and neuter gender (e.g., her and its) and vice versa. Headings and subheadings, if any, are used for convenience only, and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations or one or more configurations. A phrase, for example, a configuration may refer to one or more configurations and vice versa.

What is claimed is:

1. A computer-implemented method for, providing a security process for wireless devices, the method comprising:
receiving a beacon frame at a beacon receiver, wherein the beacon frame is transmitted by a beacon transmitter, and the beacon frame contains a beacon identifier, the beacon identifier is digitally signed;
transmitting a message with the beacon identifier from the beacon frame received by the beacon receiver to an arbiter for digital signature validation;
validating the beacon identifier from the message at the arbiter; and
communicating a result of the beacon identifier validation by the arbiter back to the beacon receiver.

2. The method of claim 1, wherein the beacon identifier in the beacon frame is generated by the arbiter.

3. The method of claim 1, wherein the beacon identifier is generated based on all or part of the contents of the beacon frame and the timestamp of the beacon frame but not including the cyclic redundancy check or frame redundancy check or both.

4. The method of claim 1, wherein the beacon identifier is cryptographically encoded and valid for a specified time duration.

5. The method of claim 1, wherein the beacon identifier of the beacon frame is generated using public key cryptography.

6. The method of claim 1, wherein the beacon identifier of the beacon frame is generated using a one-time password, passphrase, passkey, or pad.

7. The method of claim 1, further comprising sending a MAC address request by the beacon transmitter to an address assignment service for receiving a new MAC address wherein a MAC address field of the MAC address request sent by the beacon transmitter is either the new MAC address assigned by the address assignment service or selected from a pre-loaded list of MAC Addresses into the beacon transmitter.

8. The new MAC address of claim 7 assigned to the beacon transmitter by the address assignment service is valid for a specified time duration.

9. The method of claim 7, wherein the MAC address request sent by the beacon transmitter to the address assignment service is cryptographically encoded using a public key.

10. The method of claim 7 further comprising sending the MAC address request by at least one decoy beacon transmitter to an address assignment service to receive at least one pre-allocated MAC address by the address assignment service.

11. The method of claim 10 further comprising means for sending the beacon frame by at least one beacon transmitter or one decoy beacon transmitter for the purpose of preventing a rogue device to run analytics on at least one beacon transmitter and one decoy beacon transmitter.

12. A non-transitory computer-readable medium for providing a security process for wireless devices, the computer-readable medium comprising instructions that, when executed by a computer, cause the computer to:
receive, a beacon frame at a beacon receiver, wherein the beacon frame is transmitted by a beacon transmitter, and the beacon frame contains a digitally signed beacon identifier;
transmit, a message with the beacon identifier from the beacon frame received by the beacon receiver to an arbiter for digital signature validation;
validate, the beacon identifier from the message at the arbiter; and
communicate, a result of the beacon identifier validation by the arbiter back to the beacon receiver.

13. The computer-readable medium of claim 12, wherein the beacon identifier in the beacon frame is generated by the arbiter.

14. The computer-readable medium of claim 12, wherein the beacon identifier is generated based on all or part of the contents of the beacon frame and the timestamp of the beacon frame but not including the cyclic redundancy check or frame redundancy check or both.

15. The computer-readable medium of claim 12, wherein the beacon identifier is cryptographically encoded and valid for a specified time duration.

16. The computer-readable medium of claim 12, wherein the beacon identifier of the beacon frame is generated using public key cryptography.

17. The computer-readable medium of claim 12, wherein the beacon identifier of the beacon frame is generated using a one-time password, passphrase, passkey, or pad.

18. The computer-readable medium of claim 12, further comprising instructions to send a MAC address request by the beacon transmitter to an address assignment service for receiving a new MAC address wherein a MAC address field of the MAC address request sent by the beacon transmitter is either the new MAC address assigned by the address assignment service or selected from a pre-loaded list of MAC Addresses into the beacon transmitter; the new MAC address assigned to the beacon transmitter by the address assignment service is valid for the short specified time duration.

19. The computer-readable medium of claim 18, wherein the MAC address request sent by the beacon transmitter to the address assignment service is cryptographically encoded using a public key.

20. The computer-readable medium of claim 18 further comprising instructions to send the MAC address request by at least one decoy beacon transmitter to the address assignment service to receive at least one pre-allocated MAC address by the address assignment service.

21. A system for, providing a security process for wireless devices, the system comprising:
one or more processors; and
a memory comprising instructions that, when executed by the one or more processors, cause one or more processors to:
receive, a beacon frame at a beacon receiver, wherein the beacon frame is transmitted by a beacon transmitter, and the beacon frame contains a beacon identifier, the beacon identifier is digitally signed;
transmit a message with the beacon identifier from the beacon frame received by the beacon receiver to an arbiter for digital signature validation;
validate the beacon identifier from the message at the arbiter; and
communicate a result of the beacon identifier validation by the arbiter back to the beacon receiver.
